(19) United States
(12) Patent Application Publication
(10) Pub. No.: US 2007/0245020 A1
(43) Pub. Date: Oct. 18, 2007

(54) Publishing scheduler for online content feeds

(75) Inventor: Edward Stanley Ott IV, Palo Alto, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/406,894

(22) Filed: Apr. 18, 2006

(51) Int. Cl. G06F 15/173

(52) U.S. Cl. 709/225

(57) ABSTRACT

The present invention relates to a system and method for publishing files online via feeds. In one aspect, the present invention includes a method and system for allowing web site operators to cause files to be published automatically based on directive information provided by a user. In one example, the present invention may include a computer-implemented method of providing access over time to a plurality of files via a feed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media content through their computers. Such content can be in the form of audio music, music videos, television programs, sporting events or any other form of audio or video content that a user wishes to watch, read, listen to or otherwise perceive in some manner.

For example, podcasting is a method of publishing digital media content, typically audio programs, via the Internet, allowing users to subscribe to a feed of new files (e.g., .MP3s audio files). Podcasting enables independent producers to create self-published, syndicated media content, such as “radio shows,” and gives broadcast news, radio, and television programs a new distribution method. Listeners may subscribe to feeds using “podcatching” software (a type of aggregator), which periodically checks for and downloads new content automatically.

Electronic distribution of content over the Internet, podcasting being just one example, has become a very popular and accepted media delivery paradigm. This success has caused the number and variety of podcasts, of types of content distributed and of content delivery sites available to clients to grow exponentially. Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and downloads new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, but the “podcast” name remains most associated with audio. Other names are sometimes used for casting other forms of media, such as blogcasting for text and vcasting or vodcasting for video. For the purposes of this application, podcast is used in its most general sense to refer to a feed of new files in any format (e.g., .MP3, .MPEG, .WAV, .JPG) and containing any content (e.g., text-based, audible, visual or some combination) that can be subscribed to by a client. Also, for the purposes of this discussion an individual podcast may be referred to as a series, and each distinct new file in the series may be referred to as an individual episode of the series.

Podcasting is supported by underlying feed formats such as RSS. RSS is a family of XML file formats for web syndication used by (amongst other things) news websites and weblogs. The abbreviation is used to refer to the following standards: Rich Site Summary (RSS 0.91); RDF Site Summary (RSS 0.9 and 1.0); and Really Simple Syndication (RSS 2.0).

The technology behind RSS allows a client to subscribe to websites that have provided RSS feeds; these are typically sites that change or add content regularly. To use this technology the client needs some type of aggregation service or aggregator. The aggregator allows a client to subscribe to the podcasts that the client wants to get updates (i.e. future media files in the feed) on.

The RSS formats provide web content or summaries of web content together with links to the full versions of the content, and other meta-data. This information is delivered as an XML file called RSS feed, webfeed, RSS stream, or RSS channel. In addition to facilitating syndication, RSS allows a website's frequent readers to track updates on the site using an aggregator.

RSS is widely used by the weblog community to share the latest episodes' headlines or their full text, and even attached multimedia files. In mid 2000, use of RSS for podcasting text spread to many major news organizations, including Reuters, CNN and the BBC, until under various usage agreements, providers allow other websites to incorporate their “syndicated” headline or headline-and-short-summary feeds. RSS is now used for many purposes, including marketing, bug-reports, or any other activity involving periodic updates or publications.

A program known as a feed reader or aggregator can check RSS-enabled webpages on behalf of a user and display any updated articles that it finds. It is now common to find RSS feeds on major web sites, as well as many smaller ones.

Client-side readers and aggregators are typically constructed as standalone programs or extensions to existing programs like web browsers. Such programs are available for various operating systems.

Podcasting has become a very popular and accepted media delivery paradigm. This success has caused the number and variety of podcasts available to clients to grow exponentially. Potential podcast consumers are now confronted with the problems of how to find podcasts, how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

### SUMMARY OF THE INVENTION

The present invention relates to a system and method for publishing files online via feeds. In one aspect, the present invention includes a method and system for allowing web site operators to cause files to be published automatically based on directive information provided by a user. In one example (which example is intended to be illustrative and not restrictive), the present invention may include a computer-implemented method of providing access over time to a plurality of files via a feed.

In one aspect, a method may include receiving a master feed identifying a plurality of future times associated with at least one of a plurality of media files, and detecting the occurrence of a first time corresponding to one of the plurality of future times. The method may also include automatically generating a first feed in response to detecting the occurrence of the first time, including modifying a first copy of the master feed. The first feed may include a first link to at least one of the plurality of media files. The method may also include automatically making the first feed accessible in response to the detecting the occurrence of the first time. The method may further include detecting the occurrence of a second time corresponding to one of the plurality of future times, the second time different from the first time, and automatically generating a second feed in response to the detecting the occurrence of the second time. The generating of the second feed may include modifying a second copy of the master feed and the second feed may include a second link to at least one of the plurality of media files. The method may also include automatically making the second feed accessible in response to the detecting the occurrence of the second time.

In one embodiment, the method may include receiving at least one of the plurality of media files before the occurrence of the first time and before the occurrence of the second time. In another embodiment, the method may include moving at least one of the plurality of media files in response to the detecting the occurrence of the first time. In yet another embodiment, the master feed includes a plurality of network access locations corresponding to the plurality of media files.

Another aspect of the present invention may include a computer-implemented method of providing access over time to a plurality of episodes via a feed, including receiving directive information. The directive information may identify a first episode as being at a first network access location and as being associated with a first event, and may identify a second episode as being at a second network access location and as being associated with a second event. The second event may be different from the first event.

In this aspect, the method may include detecting the first event, and making accessible a first feed in response to detecting the first event. The first feed may include a first link to the first episode at the first network access location.

In one embodiment, the method may include detecting the second event, and making accessible a second feed in response to detecting the second event. The second feed may include a second link to the second episode at the second network access location. In another embodiment, the method includes creating the second feed by modifying the first feed to include the second link to the second episode at the second network access location. In yet another embodiment, the method includes overwriting the first feed with the second feed.

In one embodiment, the method includes storing a template including the directive information, and creating the first feed and the second feed from the template.

In another embodiment, the method includes receiving the template. The template may contain the directive information used to publish a series of episodes. In another embodiment, the template is a feed identifying each of the series of episodes.

In one embodiment, each episode is a media file. In another embodiment, receiving directive information is performed at a first time, wherein the first event is an occurrence of a second time after the first time. In yet another embodiment, the event may be detection of a phone call, an occurrence of a keyword in a newspaper headline, detection of an electronic message, a pseudo-random occurrence, and a counter reaching a certain number.

In one embodiment, the method includes moving the first episode to the first network access location. In another embodiment, the first episode is not accessible at the first network access location when the directive information is received. In yet another embodiment, the method includes moving the first feed in response to detecting the first event. In another embodiment, the method includes receiving the first episode and the second episode with the directive information.

In one embodiment, the method includes making accessible the first feed through moving the first feed to an accessible location. In another embodiment, the first feed lacks a link to the second episode at the second network access location. In yet another embodiment, the method includes transmitting a notification that the first event has been detected. In another embodiment, the first network access location is represented by a first uniform resource identifier (URI) and the second network access location is represented by a second URI.

Another aspect of the present invention may include a system for automatically modifying a feed over time. In this aspect, the system may include directive information including a first location relating to a first media file and a first publishing criterion relating to the first media file. The first publishing criterion may be independent from the creation, reception and/or transmission of the directive information. The directive information may further include a second location relating to a second media file and a second publishing criterion relating to the second media file, the second publishing criterion different from the first publishing criterion.

In this aspect, the system may include a publishing entity adapted to make the first media file accessible based on the directive information. The publishing entity may be further adapted to make the first media file accessible by modifying a first feed in response to detection of the first publishing criterion being satisfied. The modifying of the first feed may include modifying the first feed to include a first link to the first media file. In one embodiment, the publishing entity is adapted to receive the directive information from a user before the occurrence of the first publishing criterion is satisfied.

In one embodiment, the publishing entity moves the first media file to the first location in response to detection of the first publishing criterion being satisfied. In another embodiment, the publishing entity makes the first media file accessible via moving the first feed to an accessible location. In yet another embodiment, the publishing entity makes the second media file accessible, based on the directive information.

In one embodiment, the publishing entity makes the second media file accessible. In another embodiment, the publishing entity makes the second media file accessible by modifying a second feed in response to detection of the second publishing criterion being satisfied. In yet another embodiment, the modifying of the second feed may include modifying the second feed to include a second link to the second media file. In another embodiment, the publishing entity is adapted to receive directive information and episodes. In yet another embodiment, the publishing entity is adapted to receive a template feed containing directive information and to create the first feed from the template feed.

Another aspect of the present invention may include a method including publishing via a first feed a series of episodes according to a first schedule, publishing via a second feed the series of episodes according to a second schedule, and providing access to the second feed for a fee.

In one embodiment, the fee is paid by an advertiser in exchange for a user accessing episodes including advertisements and/or in exchange for the user viewing advertisements. In another embodiment, the method includes receiving directive information pertaining to providing access to the series of episodes according to the first schedule and providing access to the series of episodes according to the second schedule. In another embodiment, the directive information includes information such as location information for the series of episodes, scheduling information relating to the first schedule and the second schedule, and fee information relating to the second schedule.

In one embodiment, the method includes generating the first feed from the directive information, and generating the second feed from the directive information. In another embodiment, the method includes receiving a request for the second feed from a user. In yet another embodiment, the method includes billing the user for the fee.

In one embodiment, the method includes receiving account information of the user, such as credit card information, online debit account information, and bank account information. In another embodiment, the method includes moving the series of episodes to an accessible location according to the first schedule. In yet another embodiment, the method includes moving the series of episodes to an accessible location according to the second schedule.

In one embodiment, the method includes modifying the first feed according to the first schedule. In another embodiment, the method includes moving the first feed. In yet another embodiment, the method includes modifying the second feed according to the second schedule. In another embodiment, the method includes moving the second feed.

Additional features of the invention will be set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a schematic illustrating an exemplary network architecture according to one embodiment of the present invention;

FIG. 2 is a schematic illustrating an embodiment of a publishing entity;

FIG. 3 is a schematic illustrating an embodiment of directive information database;

FIG. 4 illustrates an embodiment of a process for publishing a file via a feed;

FIG. 5 illustrates another embodiment of a process for publishing a file via a feed;

FIG. 6 illustrates another embodiment of a process of publishing an episode via a feed; and

FIG. 7 illustrates an embodiment of a graphical user interface for presenting a publishing scheduler.

### DETAILED DESCRIPTION OF PREFERRED EMBODIMENTS

Podcasts are generally updated when a content provider revises series directory information identifying a change or modification in the episodes. Thus, a podcast may be automatically updated and the episodes within the podcast published by inserting those episodes into a series directory. The update/modification and the publishing on the Internet are thus synchronized, or roughly so, to provide users with content immediately after it becomes available.

As used herein, the terms “content”, “episodes”, “media”, or “media files” are used broadly to encompass any product type or category of renderable, experienceable, retrievable, computer-readable filed and/or stored media, either singly or collectively (e.g., in a series), and individual items of media or content are generally referred to as episodes, entries, songs, tracks, pictures, images, items or files, however, the use of any one term is not to be considered limiting as the concepts features and functions described herein are generally intended to apply to any item or file that may be experienced by a user, whether aurally, visually or otherwise, in any manner now known or to become known. An item or a file may be any information, identifiable, storable and/or retrievable. Further, the term content includes all types of media content such as audio and video and products embodying the same.

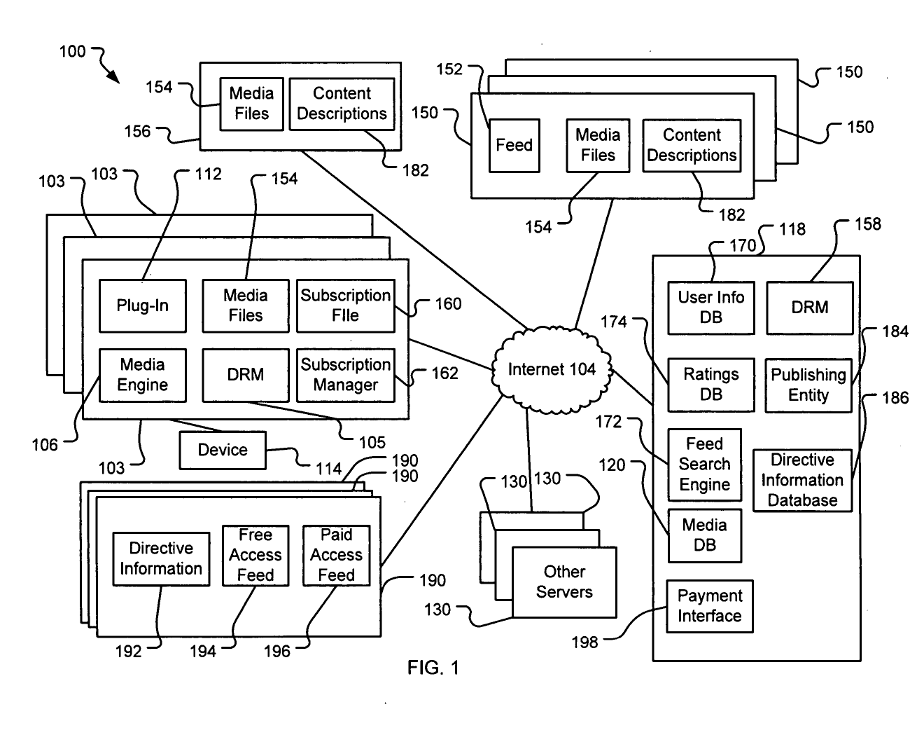

Embodiments of the present invention will now be discussed with reference to the aforementioned figures, wherein like reference numerals refer to like components. Referring now to FIG. 1, the architecture of an embodiment of the present invention is shown in schematic form. As can be seen in FIG. 1, a system 100 according to one embodiment of the present invention is shown. In general the system 100 allows users to find, experience, share and otherwise utilize different media. The system 100 also allows a user to publish and disseminate files both manually and automatically (e.g., through use of a publishing entity). Although numerous exemplary embodiments will be discussed in terms of music and/or audio files, this invention can also be utilized with any form of audio, video, digital or analog media content, as well as any other media file type now known or to become known.

A user may utilize a computing device 103 having a computing device, such as personal computer (PC), web enabled cellular telephone, personal digital assistant (PDA) or the like, coupled to the Internet 104 by any one of a number of known manners. Furthermore, a computing device 103 may include an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. A computing device may also include a media engine 106 that, among other functions to be further described, provides the ability to convert information or data into a perceptible form and manage media related information or data so that user may personalize their experience with various media.

A media engine 106 may be incorporated into computing device 103 by a vendor of the computing device 103, or obtained as a separate component from a media engine provider or in some other art recognized manner. As will be further described below, it is contemplated that media engine 106 may be a software application, or a software/firmware combination, or a software/firmware/hardware combination, as a matter of design choice, that serves as a central media manager for a user and facilitates the management of all manner of media files and services that the user might wish to access either through a computer or a personal portable device or through network devices available at various locations via a network. As used herein, the term media file is used generically to refer to an item of media, as well as associated metadata and/or network location information for that item. A computing device 103 may also be referred to as a rendering device 103 to indicate that it is adapted to retrieve and render media files from the network.

Computing device 103 also may include storage for local media files 154 and/or other plug-in programs 112 that are run through or interact with the media engine 106. In one embodiment, media files 110 are audio files. In another embodiment, media files are video files. In yet another embodiment, media files can be a combination file compatible with a MPEG-21 standard or the like. Computing device 103 also may be connectable to one or more portable devices 114 such as a compact disc player and/or other external media file player, commonly referred to as an MP3 player, such as the type sold under the trade name ipod by Apple Computer, Inc., that is used to portably store and play media files.

Local files may be stored on a mass storage device (not shown) that is connected to the computing device 103 or alternatively may be considered part of the computing device 103. The mass storage device and its associated computer-readable media, provide non-volatile storage for the computing device 103. Although the description of computer-readable media contained herein refers to a mass storage device, such as a hard disk or CD-ROM drive, it should be appreciated by those skilled in the art that computer-readable media can be any available media that can be accessed by the computing device 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Additionally, computing device 103 may contain Digital Rights Management software (DRM) 105 that protects the copyrights and other intellectual property rights of the user's media files by enabling secure distribution and/or preventing or hampering illegal distribution of the media files. In one embodiment, DRM 105 encrypts or decrypts the media files for controlled access by authorized users, or alternatively for marking the content with a digital watermark or similar method so that the content can not be freely distributed. Media engine 106 may use the DRM information to ensure that the media files being experienced through media engine 106 are not copied to or shared with users that are unauthorized to listen to or view the content.

The computing device 103 may include the software necessary to subscribe to podcasts. In the embodiment shown, the computing device 103 includes a subscription file 160, such as an OPML file. The subscription file 160 maintains information that identifies the podcasts to which the user has subscribed. The subscription file 160 may include a list of feeds 152 and the feed locations.

The computing device 103 also includes a subscription manager 162. The subscription manager 162 can perform the podcatching functions of an aggregator and can periodically poll the feeds identified in the subscription file 160 to determine if new episodes of the podcast are available. Upon determination that a new episode is available, the subscription manager 162 may notify the user or may automatically download the episode to the computing device, such as by retrieving it from a location, such as a media server 150, via the network 104.

A feed 152 is a file that may be used to communicate that a file is accessible. For example, a feed 152 may include a link to location where a file may be accessed. An entity may follow the link to access the file. Therefore, by publishing (e.g., making accessible) a feed 152, a file 154 may be made accessible. A podcast may reference a feed to check whether the feed has been updated (e.g., a link in the feed has modified).

The system 100 also includes community server 118. The community server 118 collects and stores information generated by a community of users. In order to increase the size of the user community, the community server 118 may offer a substantial amount of content to its users, such as news content, music downloads, weather information and news groups.

In order to access some or all of the content on the community server 118, users may be required to become members of the community or otherwise be given a member identifier (ID) that identifies the member within the community. Member IDs may then be used by the community server 118 to associate information provided by and about a particular user with that user. In an embodiment, members are required to log into the community, such as with a user name and password, in order to obtain full access. Member IDs and other community information may be stored on a data structure (such as a cookie) on the user's computing device 103 as well as on the community server 118 to facilitate the membership. Logging into the community may require an act on the part of the user, such as entry through a log in user interface, or may be automatic depending on the implementation.

In the embodiment shown, community server 118 includes a media database 120, which stores or communicates with storage devices storing various metadata attributes associated with particular items of media content. Database 120 may be distributed over multiple servers provided with mass storage devices or other forms of computer-readable media or contained in a large mass storage device accessible the community server 118. Other servers 130 make other content and services available and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, web page or perceptible audio, video or image content. It should be also be understood that although the present invention is described in terms of media content and specifically audio content, the scope of the present invention encompasses any file including any content or media format heretofore or hereafter known.

The community server 118 also includes a database 170 of user information. The user information database 170 includes information about users that is collected from users or generated by the community server 118 as the user interacts with the community server 118. In one embodiment, the user information database 170 includes user information such as user name, gender, e-mail and other addresses, user preferences, etc. that the user may provide to the community server 118. In addition, the server 118 may collect information directly or indirectly from the user's computing device 103, such as the podcasts to which the user has subscribed, what media searches the user has performed, how the user has rated various podcasts and other content items, etc. In one embodiment, user information may include any information about the user, including login information, account history, payment information, and authentication information. In effect, any information related to the user and the content items that user consumes or interacts with that is available to the community server 118 may be stored in the user information database 170.

In one embodiment, the community server 118 includes a ratings database 174. The ratings database 174 may include a list of content items, such as media files 154 or feeds 152, known to the community server 118. This list may be periodically refreshed as the server 118 searches for new content items or new content items are registered with the community server 118 by content publishers.

For the purposes of illustration, the system 100 will be described in detail with specific reference to podcasts as exemplified content items. Podcasts make a good example because in discussing podcasts many additional functionalities can be discussed which may not apply to an individual content item. For instance, while each episode of a podcast is a content item, the podcast series itself may also be considered a content item and a content item for which additional functionalities, such as subscription, can be discussed. One skilled in the art will realize that any of the features described with reference to podcasts can be adapted to any particular content item.

Using podcasts as an example, the ratings database 174 may search for new feeds 152 and for feeds that have been removed from access to the internet 104. Such a function of a ratings database 174 may not be necessary if the searching ability of the server 118 is sufficient to quickly provide user with updated and accurate feed information in response to a user search. The ratings database 174 may include all of the information provided by the feed 152. In addition, the ratings database 174 may include other information generated by the community server 118 or by users. Thus, the ratings database 174 may contain information not known to or generated by the publisher of the feed 152.

In one embodiment, the databases (e.g., 120, 174, 170, 186) may be separate and distinct databases, while in an alternative embodiment some databases may be combined in whole or in part, such as into a single database. In addition, databases may be part of the community server 118 or may be located on separate computing devices that are in communication with the community server.

In an embodiment, community members are allowed to provide information to be associated with any content item including with feeds or with particular episodes of feeds. Thus, the user after perceiving data may rate an episode, say on a scale of 1-5 stars, write a review of the episode, and enter tags to be associated with the episode 152. All this consumer-generated data may be stored in the ratings database 174 and associated with the appropriate episode 152 for use in future searches.

In one embodiment, the community server 118 includes a search engine 172. In an embodiment, the search engine 172 performs multiple functions including crawling a network 104 to identify feeds and episodes that are linked to by feeds on the network. In an embodiment, the search engine 172 may retrieve feed information, store the information in the ratings database 174, and provide a means for computing devices 103 to easily search the ratings database 174 for feeds and episodes.

Because of their very nature, feeds 152 are expected to change (e.g., be modified) over time through the addition of new media files 154 as episodes of the feed 152. In an embodiment, the search engine 172 periodically and automatically crawls the network 104 to find new feeds 152 and for previously identified feeds 152 that have changed since the last time the search engine 172 inspected the feed 152. When crawling the network 104, the search engine 172 can use any suitable network searching or crawling methods, such as for example, the method for crawling information on a network described in commonly owned U.S. Pat. No. 6,021,409, titled “METHOD FOR PARSING, INDEXING AND SEARCHING WORLD-WIDE-WEB PAGES.” The search engine 172 may create one or more new entries in the ratings database 174 for every new feed 152 it finds. Initially, the entry or entries may contain the location of the feed, an identifier of the feed (such as its name), and some or all of the information contained in or otherwise provided by or associated with the feed 152. For example, for an RSS feed, the information stored in entries may include some or all of the metadata within the RSS feed file. The feed information may be retrieved by the search engine 172 from the feed 152 and stored in the ratings database 174 so that the ratings database contains some or all of the information provided in the feed 152. Such information may include the feed description, episode descriptions, episode locations, etc.

In one embodiment, the ratings database 174 may also include such information as reviews of the quality of the feeds, including reviews of the series as a whole and reviews specific to each episode in a given feed 152. The review may be a rating such as a “star” rating and may include additional descriptions provided by community members. The reviews and ratings may be received by the community server 118 directly from community members through a rating and review user interface. In an embodiment, in order for a user to provide a rating or a review for a content item, the user must be a member of the community. Furthermore, in an embodiment the operator of the community server 118 maintains the ratings and review information as a community forum independent of any content publisher's control or oversight. Thus, content publishers can not remove negative information. Ratings and review information submitted by content publishers may be so identified in order to provide the members of the community with an understanding of the potential bias of the information.

In addition to maintaining information specific to series and individual episodes 154 within the series 154, the ratings database 174 may also include information associated with content publishers 190, sponsors of the feeds 152, episodes 154, topics discussed in the feeds or episodes, and/or people in the feeds or episodes. The ratings database 174 may also include information concerning publishers of content.

In order to facilitate client searches for podcasts, the feed search engine 172 may provide a graphical user interface to user's computing devices 103 allowing the user to search for and subscribe to feeds 152 using the community server 118. In one embodiment, the graphical user interface may be an .HTML page served to a computing device 103 for display to the user via a browser. Alternatively, a graphical user interface may be presented to the user through some other software on the computing device 103. Through a graphical user interface, the feed search engine 172 may receive user search criteria. The search engine 172 may then use the search criteria as parameters to identify feeds 152 that meet the user's criteria. The search may include an active search of Internet 104, a search of the ratings database 174, or some combination of both 174. The search may include a search of the descriptions provided in the feed 152 of the series and each particular episode 154 in the series. The search may also include a search of the third party-provided tags, ratings, and reviews and other information associated with feeds 152 listed in the ratings database 174 but not provided by the feeds 152 themselves. The results of the search are then displayed to the user.

In one embodiment of the present invention, similar to the DRM software 105 located on the user's computing device 103, the community server 118 may maintain DRM software 158 which tracks the digital rights of media files 154 located either in the media database 120 or stored on a user's computing device. Thus, for example, before the community server 118 streams or serves up or transfers any media files to a user, it validates the rights designation of that particular piece of media 154 and only serves streams or transfers the file if the user has the appropriate rights. This may be determined by an inspection of information contained on the computing device 103, in the user information database 170, or both. In another embodiment, the rights designation of a particular file 154 may also be determined from information provided by a payment interface 198.

The system 100 also includes a number of media servers 150, that are remote from the computing devices 103 and the community server 118 and that publish podcasts. In one embodiment remote means remote in the logical, network sense in that each media server 150, each computing device 103 and the community server 118 may be accessed using different domain names as their network locator, such as the Uniform Resource Locator (URL) or the Uniform Resource Identifier (URI). For example, the community server 118 may be accessed by a URL of “http://podcast.yahoo.com” while each media server 150 may have a different URL such as “www.abcnews.com” and “www.npr.org”. The computing devices 103 may have dedicated URLs or may be devices that can intermittently connect to the Internet 104 and are given temporary URLs by the system through which they connect. In another embodiment, Internet Protocol (IP) addresses for each computing device 103, media server 150 and the community server 118 are different, indicating that the devices are remote from each other, at least in a logical sense.

The media servers 150 store content, such as media files 154 and feeds 152, and make the content accessible to consumers' computing devices 103. In the podcast example, media servers 150 include one or more feeds 152, such as RSS feeds, that are accessible through the network 104, such as the Internet as shown. The feeds 152, as will be described in greater detail below, include information about the feed (series information) as well as information about the various media files 154 (e.g., episodes) of the feed 152. The feed 152 also identifies the episodes so that they can be retrieved by a subscription manager on a computing device 103. The media file 154 may reside on the media server 150 with the feed 152, or may be located on yet another server 156 that is, in fact, remote from the podcast server 150 with the feed 152.

As illustrated in FIG. 1, each user's computing device 103, the community server 118 and media servers 150, as well as the other servers 130, 156 are communicatively connected via the Internet 104. In alternate embodiments, different components of the system may be communicatively coupled differently, for example each may be coupled directly to each other wirelessly or by a local or wide area network (WAN) or the like. Additionally, functional components can be distributed so that certain functions of the search engine 172 may be performed at community server 118, or distributed in modular fashion for operation at various locations throughout the system 100. Thus, any description herein of a function or component being associated with a particular device or component or location is merely one possible embodiment.

The search engine 172 also may provide users with additional functionality and convenience. A user interface provided by the search engine 172 to the user's computing device 103 may allow the user to subscribe to a displayed feed (via a subscribe button), listen to an episode of a displayed feed (via listen button), and obtain the complete information on the feed (via clicking on the hyperlinked title) from the same interface. A user need not know where the feed 152 resides (e.g., on the Internet 104) and need only to interact with the search engine's user interface to perform these actions. Furthermore, the user does not need to explicitly direct his computer to access the publisher's site to subscribe, listen or obtain additional information on a feed.

The system 100 may include a publisher 190, an entity that wishes to have media files 154 published according to a schedule or based on a particular event or happening. The publisher 190 may communicate with the community server 118 via the Internet 104. The publisher 190 may solicit (via communications with a publishing entity 184 and/or the community server 118 generally) the publishing of media files 154.

In one embodiment, a publisher 190 contacts the community server 118 and establishes a user account with the community server. In another embodiment, the community server 118 may contact a publisher 190 who already provides a feed to users. The community server 118 may contact a publisher 190 in order to solicit the publisher to use the publishing entity 184 (discussed in greater detail below) to automatically publish media files 154.

The publisher 190 may store a free access feed 194 and a paid access feed 196. The free access feed 194 and the paid access feed 196 may allow access to the same files but may differ in the accessibility, location and cost of access of the feeds. For example, the paid access feed 194 may be, upon payment of a fee, accessible earlier than the free access feed 196. In one embodiment, the free access feed 194 is accessible at no charge to any user of the Internet 104. In another embodiment, the free access feed 194 is accessible at no charge, but only to users who have registered with the community server 118 and/or the publisher 190. In one embodiment, the paid access feed 196 is accessible to users in exchange for a fee. In another embodiment, the paid access feed 196 is accessible by users for free, and the files 154 referenced in the paid access feed are only accessible by users in exchange for a fee.

The directive information 192 contains information for publishing episodes or media files 154 according to a schedule (e.g., as a series of episodes). In one embodiment, the directive information includes locations of files 154, a sequence in which to publish the files, and a schedule of times (and/or dates) at which to publish the files. In another embodiment, the directive information includes locations of feeds 152. The directive information 192 may also include publishing criteria, such as times, events, or other criteria that trigger the publishing of files 154 via feeds 152.

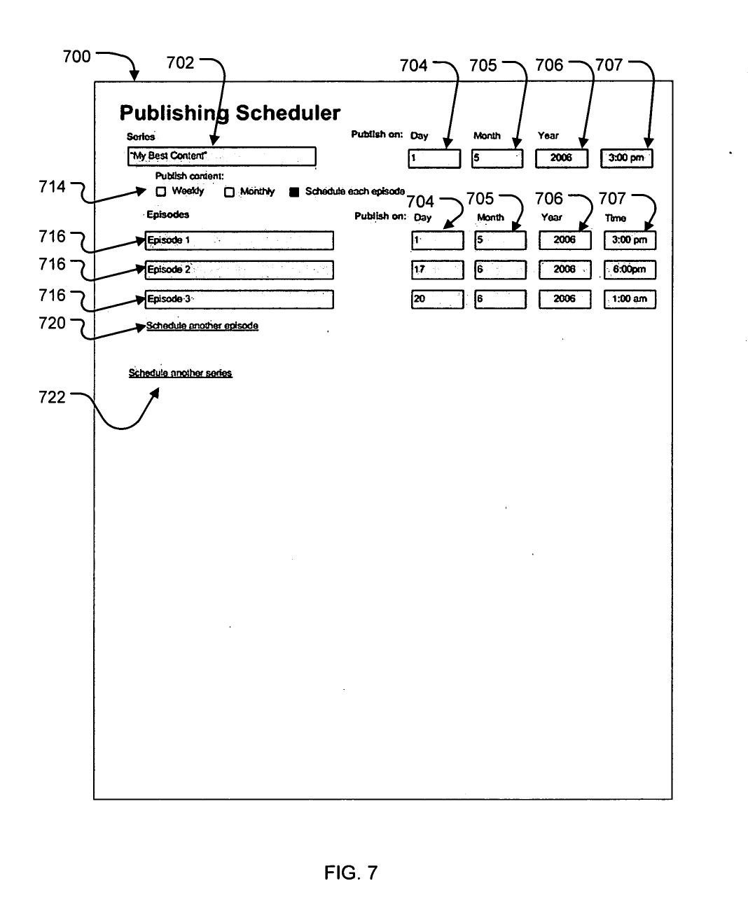

In one embodiment, the publisher 190 may store information relating to the publishing of files, information such as feeds (e.g., free access feed 194, paid access feed 196) and directive information 192. For example, the publisher 190 may store directive information and then upload it (e.g., in some form, as one specially formatted file). In another embodiment, the publisher 190 is a user's computer which accesses the community server 118 via a browser and inputs information relating to publishing feeds 152. For example, the user may use a computer to access a graphical user interface described further herein and described in relation to FIG. 7 below.

As used herein, the term “fee” should be understood as something of value including, but not limited to, currency and its equivalents. For example, a fee may be paid by a user through transferring currency, viewing an advertisement, or accessing content containing an advertisement. A fee, likely a monetary fee, may also be paid by an advertiser on behalf of a user who views an advertisement, or to the community server 118 in exchange for arranging the user to access content containing an advertisement.

The term “automatic” or “automatically” as used herein should be understood to refer to actions that happen without significant further user input or intervention. It should not be limited to instantaneous/simultaneous performance or instantaneously/simultaneously performing some action.

In one embodiment, the directive information 192 may be in the form of a schedule, including dates and times associated with media files 154. In another embodiment, the directive information may be in the form of a master feed 152 or a template feed 152 from which other feeds 152 may be derived. For example, the master feed 152 may contain a group of directive information 192 formatted as a feed 152, such that the feed contains links and publishing criteria useful for creating and publishing feeds automatically. In yet another embodiment, the master feed 152 may be formatted as a template (such as a database or spreadsheet) linking publishing criteria and media files 154.

It should be noted that the directive information 192, though it is depicted in FIG. 1 as being contained within the publisher 190, may also be distributed and may be stored in the directive information database 186, or elsewhere. For example, directive information may include a file folder structure (e.g., a folder denoting files to be published next week), file name (e.g., “song for release 01-15-07”) or metadata associated with a file 154 (e.g., a marker linking the file 154 with the airing of a television show).

The community server 118 includes a directive information database 186. In one embodiment, the directive information database 186 is used by the community server 118 to provide the publishing entity 184 with guidance and criteria for publishing media files 154. In another embodiment, the directive information database 186 is used by the community server 118 to present a publisher 190 with a schedule of dates and times when files 154 will be published. For example, the community server may allow a publisher to logon to the community server to review past and future publishing events and to make changes to the directive information 192 stored in the directive information database 186.

The community server 118 may allow a user may submit files 154 via a File Transfer Protocol (FTP) site. The community server 118 may allow a user to submit directive information via a web-based interface (e.g., a scheduling interface). The community server may allow a user to store files 154 separately from the community server. The community server also may allow the user to submit directive information 192 including locations of files residing both on the community server and separately from the community server.

The community server 118 may include a publishing entity 184. The publishing entity 184 is configured to provide scheduled and access to media files via feeds, based on directive information. As discussed above, feeds may change over time and provide access to different files 154 through providing links within the feeds 152 to files. For example, a first feed may contain a link to a first file and a link to a second file. A second feed may contain a link to the second file and a link to a third file.

As used herein, the term “location” should be understood to refer to a logical location, such as a network address unless another meaning is specified. As used herein, the term “link” should be understood to refer to a reference to a location, a name of a location, or a hyperlink to a location. For example, a link may be http://www.npr.org.

By making available the first feed, a publishing entity 184 may make a first file and a second file accessible to a user (i.e. via operating the feed and links contained therein). By making accessible a second feed, a publishing entity 184 may make the first file inaccessible and a third file accessible. The publishing entity 184 may also make a copy of the second file accessible at a different location, such as a location that requires payment or a password to access the copy of the second file. For example, the first feed 152 may provide a link that allows free access to the second file 154 and the second feed 152 may provide a link that requires payment of a fee to access a copy of the second file.

The publishing entity 184 may make files 154 accessible based on a schedule contained in directive information 192 stored in a directive information database 186.

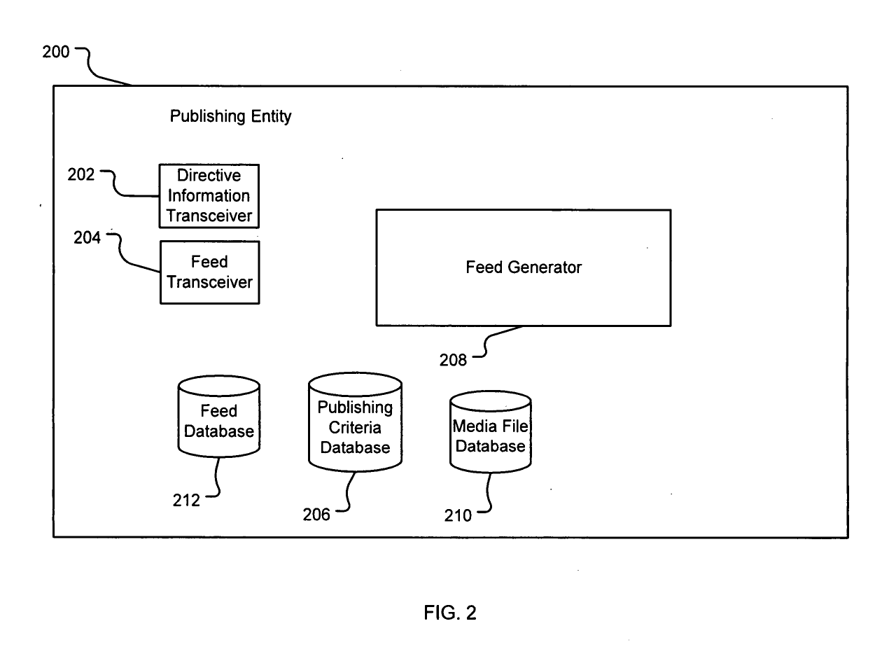

The publishing entity 184 may make the files 154 accessible in a number of ways. In one embodiment, the publishing entity 184 makes accessible a feed 152 that contains a link to file 154. For example, the publishing entity publishes a location (via a link to that location) of a file 154 in order to make accessible the file. In another embodiment, the publishing entity moves a copy of a file 154 to an accessible location. Further embodiments of publishing entities (e.g., 200) will be discussed below in relation to FIG. 2.

The community server 118 may include a payment interface 198. In one embodiment, the payment interface 198 may interact with the user information database 170, specifically, in providing information about payments made, or needed to be made, in order to access certain feeds 152 and/or media files 154. In one embodiment, the payment interface 198 may access the user information database 170 in order to recognize a user, to retrieve customer payment information (e.g., stored credit card number, online debit account information, bank account information, advertisements viewed by a user) and/or to provide access to promotions for the user based on recent purchases.

In one embodiment, the payment interface 198 may be a web-based purchasing interface. For example, the payment interface 198 may be embodied as a shopping cart type web interface. In another embodiment, the payment interface 198 may cause a payment to be made on the user's behalf without direct, explicit or contemporaneous ascent from a user. For example, the payment interface 198 may utilize information stored in a user's account to automatically deduct a payment account when a user selects or operates a paid access feed 196 or other feed 152 that has a fee associated with the feed. As another example, the payment interface 198 may retrieve information or otherwise recognize that a user has viewed an advertisement.

The payment interface 198 may be linked to by a feed 152, including a free access feed 152. For example, a feed 152 may include a link to a payment interface 198 for files that requires payment. In one embodiment, a feed 152 may include a link to a preview file 154 of a content file 154 in order to solicit a user to pay for the content file 154 through the payment interface 198. For example, upon viewing the preview file 154, a user may wish to view the content file 154, and may follow instructions in the preview file to make a payment for access to the content file. In another embodiment, the feed 152 may include a link to the payment interface 198 to solicit a payment.

The processes and methods described herein comprise only some of the embodiments of processes and methods which are part of the present invention. Those having skill in the art will recognize that various modifications may be made to the processes and methods described herein, including additions of operations, deletions of operations, modifications and re-orderings of the operations of the processes and methods.

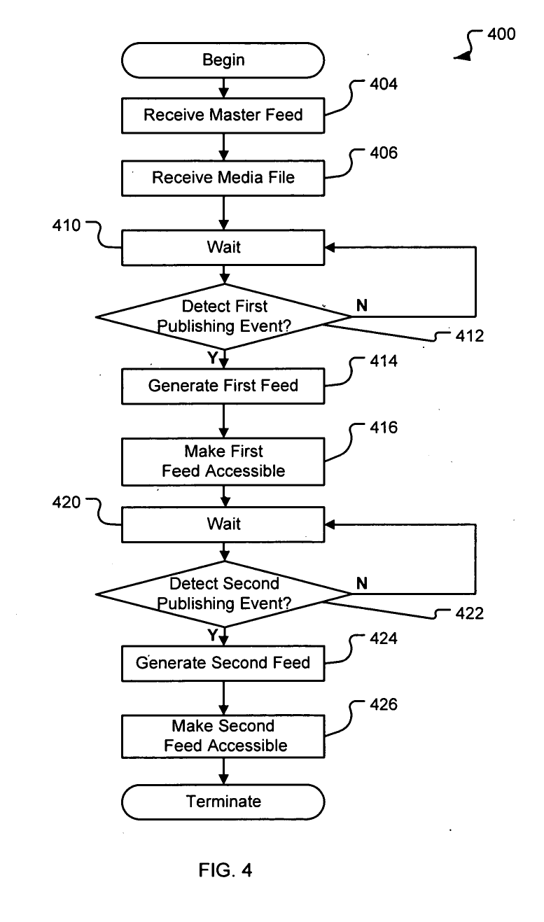

FIG. 4 illustrates an embodiment of a process 400 for publishing a file via a feed. The process 400 may be performed by the systems described herein. In one embodiment, the process may be performed by the community server described herein and by the various elements of the community server. In another embodiment, the process 400 may also be performed by various components on a personal computer of a user that is in connection with a server. Indeed, the process 400 and operations thereof (e.g., 404, 406, 410, 412) may be performed by any number of systems, either individually or in combination. In addition, the process 400 is illustrated as detecting two events over time. One skilled in the art will recognize that the scope of the invention is not limited to two events, and embodiments of the method could handle the occurrence of one, two or more events.

The process 400 may include receiving 404 a master feed. For example, a publishing entity may receive a master feed from a publisher or other server. In one embodiment, the master feed may include links to be included in feeds made accessible according to a schedule as discussed further below. In another embodiment, a master feed may contain publishing criteria. In yet another embodiment, a master feed may include a plurality of pre-assembled feeds, along with instructions (e.g., publishing criteria) relating to how to sequentially publish the feeds.

In one embodiment, the master feed may be used to publish files via providing sequential access to links within the master feed. In another embodiment, the master feed is used to publish files through copying links from the master feed into another feed.

The process 400 may include receiving 406 a media file. In one embodiment, the media file may be received for the purpose of publishing the file. In another embodiment, the media file may be received for the purpose of storing the file. In yet another embodiment, the media file may be received for the purpose of verifying an attribute about the file (e.g., the ownership of rights, the authenticity of the file, the nature of the file's contents).

The process 400 may include waiting 410, 420. A waiting operation 410, 420 may be performed by waiting for a set period of time before checking if a condition has occurred. A waiting operation 410, 420 may be performed by counting down from a pseudo-randomly generated number. A waiting operation 410, 420 may also be performed by performing another task before checking if a condition has occurred.

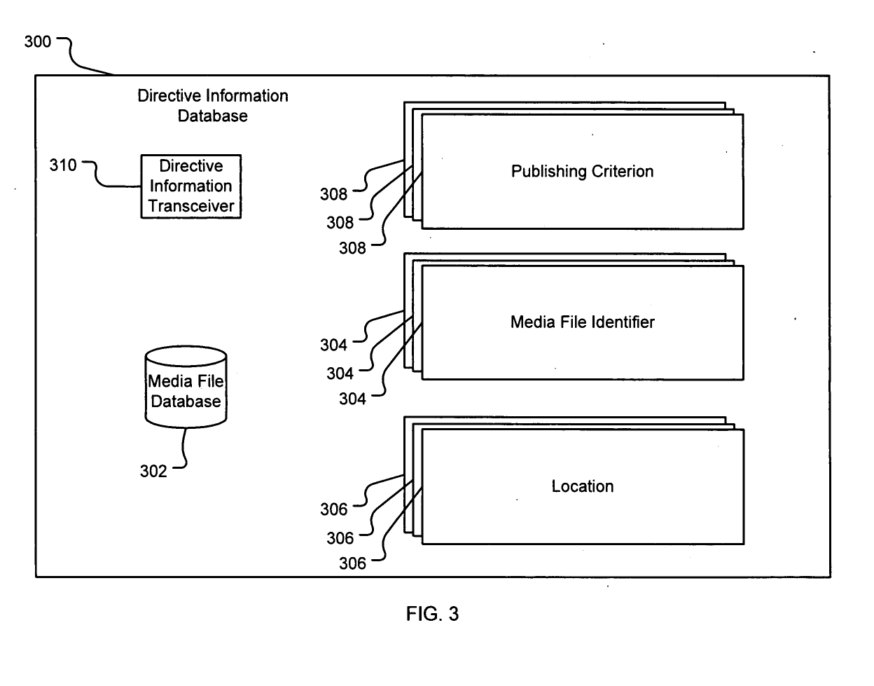

The process 400 may include detecting a first publishing event 412. A publishing event is an event that satisfies a publishing criterion. A publishing event is described further below (in relation to FIG. 3 and publishing criteria). Detecting a first publishing event 412 may be performed by monitoring any perceptible occurrence.

The detecting operation 412 may include active participation in generating the event detected. For example, the detecting operation 412 may be performed by checking a website, reading a file on a network, performing a search, checking the time of day. In one embodiment, the detecting operation 412 checks a clock against a publishing event that comprises a time. In another embodiment, the detecting operation 412 may include generating other events through, for example, performing web searches, monitoring traffic loads on parts of the Internet 104, and monitoring/performing a sequence of events.

The process 400 may include generating a feed (e.g., 414, 424). In one embodiment, a generating operation 414, 424 may be performed by creating a new feed. In another embodiment, a generating operation 414, 424 may be performed by modifying an existing feed. In one embodiment, the existing feed that is modified may be a feed that is used to access files. In another embodiment, the existing feed that is modified may be a master feed.

A generating operation 414, 424 may be performed in response (e.g., direct, indirect) to the detecting operation 412. In one embodiment, the generating operation 414, 424 may generate a feed after the detecting operation 412 detects an event that calls for the feed. In another embodiment, the generating operation 414, 424 may generate a feed after the detecting operation 412 detects an event that calls for a feed that has previously been generated. For example, a previously generated feed may have been generated 414, 424 in response to an earlier detecting operation 412 of an earlier event. Therefore, there may be at least one feed that is generated before an event that will lead to the publishing of the feed.

In one embodiment, an event that is detected by the detecting operation 412 is associated with a feed that is to be generated 414, 424 and published as a direct result of that event being detected 412. In another embodiment, an event that is detected by the detecting operation 412 is associated with a feed that is to be generated 414, 424 as a direct result of the event being detected, but is to be published as a direct result of the next (or a different) event being detected (e.g., 422).

The process 400 may include making a feed accessible 416, 426. Making a feed accessible 416, 426 may publish the files linked to by links in the feed. In one embodiment, making a feed accessible 416, 426 may include removing or modifying password protection associated with the feed. In another embodiment, the making a feed accessible operation 416, 426 is performed via moving the feed to an accessible location. In yet another embodiment, the making a feed accessible operation 416, 426 may include overwriting an old version of the feed with a new version of the feed.

Those with skill in the art will recognize that publishing and making accessible may be used interchangeably herein. Those with skill in the art will also recognize that files may be published via the publishing of feeds.

The making a feed accessible operation 416, 426 may be performed by making feeds accessible on the Internet (i.e. publishing the feeds) so that any user with the appropriate software and access permissions can download and interpret the feed and the links the feed contains. In one embodiment, the making a feed accessible operation 416, 426, results in the links contained in the feeds being accessible and, through the links, the files (and/or locations of files referenced by the links) are accessible.

In one embodiment, if the link is not accessible, the file (and/or location of a file referenced by the link) is not accessible because without knowledge of the file's location the file is effectively not accessible to the general public. Thus, the location may have been technically accessible but secret (e.g., not easily discoverable although accessible) before being named by the link in the feed.

It should be noted that control of access to the files linked to by the feeds may be used to control access to files before publishing files via links in feeds. In one embodiment, the process 400 provides control of access to a file, through, for example a DRM system, a password protection scheme, or an encryption scheme. In another embodiment, another entity (e.g., media servers) may provide control of access to a file. For example, in another embodiment making accessible operations 416, 426 may include moving or copying a file to an accessible location, or modifying the access restrictions of a file location (i.e., password or firewall protections). Such additional actions may be performed in addition to or instead of publishing links.

The process 400 may include detecting a second event 422. The detecting a second event operation 422 may be separate from the detecting a first event operation 412 and the events detected by both operations may be different events. The detecting a second event operation 422 may be performed in any of the manners described above with respect to the detecting a first event operation 412.

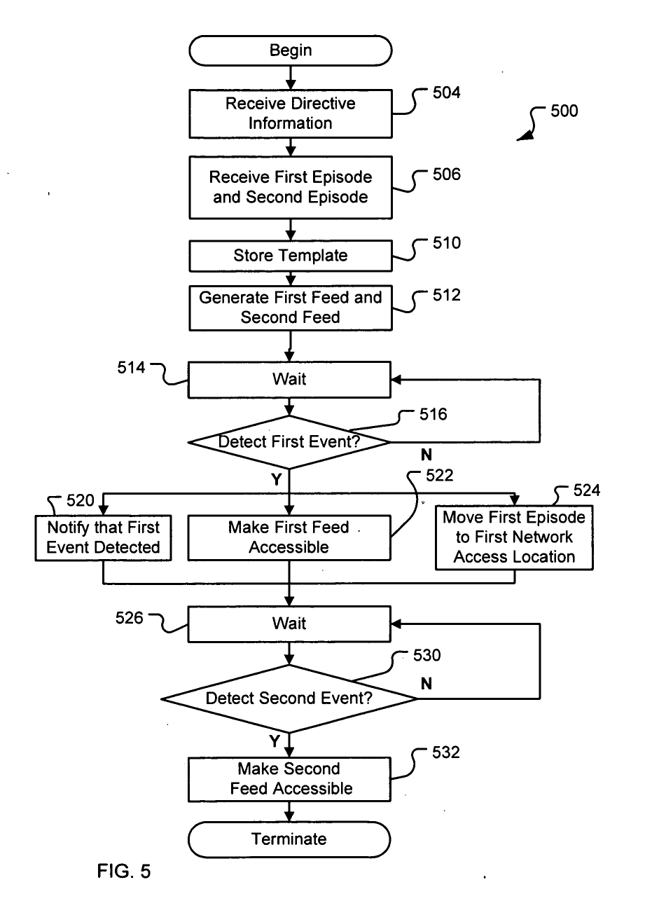

FIG. 5 illustrates another embodiment of a process 500 for publishing a file via a feed. The process 500 includes receiving directive information 504, receiving a first episode and a second episode 506, and storing a template 510. The process 500 may also include moving an episode 524 from an inaccessible location to a network access location and notifying that an event was detected 520.

The process 500 may also include generating a feed 512, waiting 514, 526, detecting an event 516, 530, and making a feed accessible 522, 532. Each of these operations 512, 514, 526, 516, 530, 522, 532 may be performed by the process 500 in manners described above in relation to the corresponding operations in FIG. 4.

The process 500 may include receiving directive information 504. In one embodiment, the directive information may include instructions for publishing a feed. In another embodiment, the directive information may include instructions for publishing files via publishing a feed. In one embodiment, receiving directive information 504 may be performed by receiving information (e.g., information elements from user interface elements such as a click stream) from a user interface. In another embodiment, receiving directive information 504 may be performed by downloading or uploading from a user (e.g., a file containing directive information). In another embodiment, an entity may generate directive information at the direct or indirect request of a user and the directive information may be received 504 from that entity.

The receiving a first episode and a second episode 506 operation may be performed in a number of manners. In one embodiment, the receiving a first episode and a second episode 506 may be performed by transmission and reception of a file. In another embodiment, a first location may be received of the first episode and a second location may be received for the second episode, the first and second locations allowing an entity to access, retrieve or move the first and second episodes.

The process 500 may move an episode to a network access location 524. In one embodiment, the process 500 may move the episode in order to publish the episode (e.g., file). For example, the process 500 may publish the episode via a feed in a similar manner to that described herein. In another embodiment, the moving an episode operation 524 may include moving the episode from a secured, secret and/or password-protected location to a more accessible location in order to provide access to the episode. In one embodiment, an episode is moved by writing the episode in a location (e.g., an accessible location). In another embodiment, an episode is moved by creating a network access location that is configured to reference a copy of the episode stored in a particular physical location. Those with skill in the art will recognize that there are many manners in which to move an episode.

The moving an episode operation 524 may be performed as part of creating a catalog of media files. In one embodiment, an episode, once being published by a publishing entity, is moved to a storage location configured to store files. In another embodiment, an episode, known by a community server to have been published (e.g., by a part of the community server such as a publishing entity, by another entity, by the episode being publicly accessible), is moved to a network location configured to store files.

The storing a template operation 510 may be performed in a number of manners. In one embodiment, a template may be a database file containing file entries correlated with publishing criteria entries and location entries. In another embodiment, a template may be formatted in .XML or another language that may be transferred directly to a feed. In yet another embodiment, a template may be stored partly as files and partly as a file structure (e.g., folders and network address links connecting the folders).

The process 500 may include creating a template (not shown). Creating a template may be performed by modifying, interpreting and repackaging directive information. In one embodiment, the directive information received is reformatted from the information's form as received into a template. In another embodiment, the directive information received is translated (and my be augmented) into a template.

In one embodiment, the process 500 includes notifying 520 that an event was detected. For example, the process 500 may send a notification to an interested and authorized party that an event was detected that may trigger the publishing of an episode via a feed. In one embodiment, the notifying operation 520 is performed via sending an electronic message. In another embodiment, the notifying operation 520 is performed by updating a user profile on a community server. In yet another embodiment, the notifying operation is performed by initiating a telephone call (e.g., land line, mobile, voice over IP).

In one embodiment, the process 500 notifies a publisher 520. The publisher may have the option of deciding whether a publishing entity should proceed with publishing the file. The publisher may have the option to interrupt the process 500. In another embodiment, the process may notify the publisher 520 that the file is presently being published. For example, notification may allow the publisher to simultaneously transmit advertisements on a website. In addition, the publisher may desire to be reminded when a file is about to be (or is being) published.

The notifying operation 520 may be conditionally related to either the making a first feed accessible operation 522 or the moving an episode operation 524 (relationship not shown). For example, the notifying operation 520, the making a first feed accessible operation 522, and the moving an episode operation 524 may depend on each other. In one embodiment, the notifying operation 520 is performed after the making a first feed accessible operation 522 and the moving an episode operation 524 have completed successfully. In another embodiment, the notifying operation 520 may be followed by a receiving a response operation (not shown) and the making a first feed accessible operation 522 and the moving an episode operation 524 may both depend on the receiving a response operation (e.g., that an authorized party has confirmed that both making a first feed accessible and moving an episode are acceptable).

The process 500 includes waiting for a first event 514 and waiting for a second event 526. In one embodiment, the events may include the occurrence of a certain date and time. In another embodiment, the events may include the parameters detected on the Internet. For example, an event may be the updating of a website, or other indication on a website such as a keyword or key-phrase being presented on a website. The event may also be another type of event as described herein.

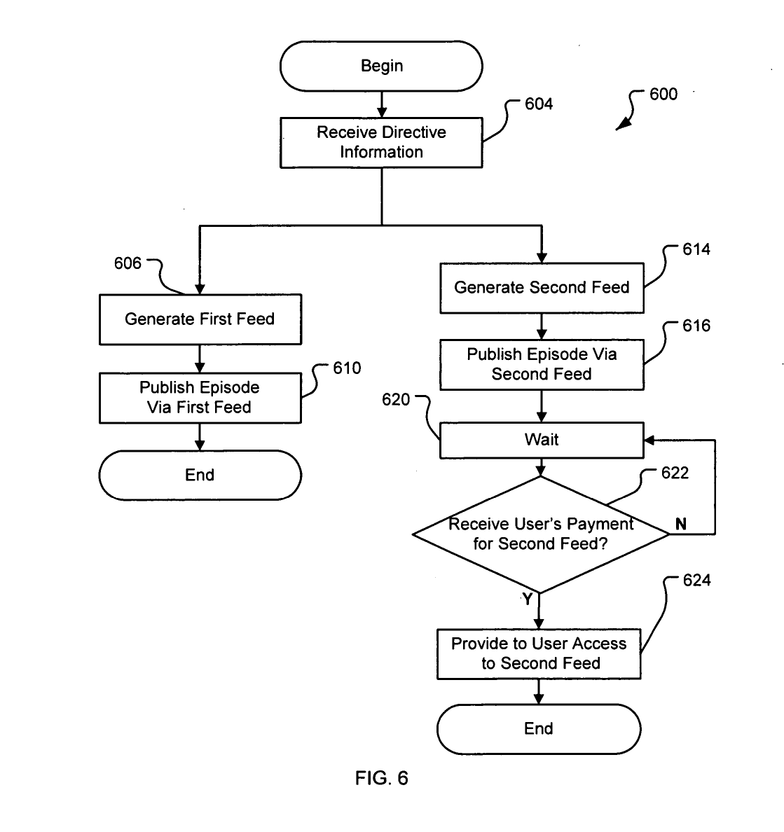

FIG. 6 illustrates another embodiment of a process 600 of publishing an episode via a feed. The process 600 publishes an episode via a first feed 610 and publishes the episode via a second feed 616. In an embodiment, the first and second feeds may be the same except for the time or events at which the episode is published. Thus, the different feeds can be used to provide different levels of access, for example for a different price. Thus, the process 600 may be used to provide different access that differs based on different user groups.

The process 600 includes receiving directive information 604, generating a first feed 606, publishing an episode via the first feed 610, generating a second feed 614, publishing an episode via the second feed 616, and waiting 620. The process 600 also includes receiving a user's payment 622 of a fee for access to the second feed, and providing a user access 624 to the second feed.

In embodiments of the process 600, the receiving directive information operation 604, the generating a first feed operation 606, the publishing an episode via the first feed operation 610, the generating a second feed operation 614, the publishing an episode via the second feed operation 616, and the waiting operation 620 may be performed in any of the manners described herein. In one embodiment of the process 600, the order in which these operations are performed may differ from the order in which similar operations are performed as described herein. For example, the generating a second feed operation 614 may be performed simultaneously, after, or before the generating a first feed operation 606. In another embodiment of the process 600, some of the operations are performed differently from other manners described herein. For example, the generating a second feed operation 614 may result in a second feed and that second feed may be written in a manner that does not affect the first feed (e.g., does not overwrite the first feed).

In the process 600, the two publishing operations 610 and 616 differ in the respect that access to the published feeds differ. For example, publishing an episode via the first feed operation 610 may include posting a freely accessible feed on the Internet whereas publishing an episode via the second feed operation 616 includes publishing a feed that is only accessible to users that have paid for such access. Thus, even though the same episode is made accessible, it may be accessible at different times through different feeds or with different attributes.

In one embodiment, the process 600 also includes receiving a user's payment 622 of a fee for access to the second feed. The receiving a user's payment operation 622 may be performed in a number of manners, including communicating with a payment interface (e.g., 198). The communicating operations (not shown) with a payment interface are described further herein and with respect to FIG. 1.

In one embodiment, the process 600 includes providing a user access 624 to the second feed. In one embodiment, the providing a user access operation 624 may be performed in direct response to the receiving a user's payment operation 622. In another embodiment, the receiving a user's payment operation 622 may be performed before a time when the process is authorized to provide a user access 624 to a feed (or access to a file through a feed). For example, a user may “pre-order” access to a feed before the feed may be ready for publishing (e.g., a publisher may wish to have a release date, but may wish to have orders before that date). Providing a user access 624 may be performed as described further herein.

The process 600 may also include restricting access (not shown) to a second feed before or after the providing a user access operation 624. Restricting access may be performed before providing access in order to provide incentive for a user to pay a fee. Restricting access may also be performed after a user's access has expired, for example, when a user's payment for access was only for a period of time or number of access events (e.g., number of times the user accesses the files).

In one embodiment, the generating a first feed operation 606 and the generating a second feed operation 614 are performed in direct response to receiving directive information 604 and are performed in advance of detecting an event (e.g., an event that may trigger a publishing operation).

In an embodiment, the process 600 may publish an episode via a first feed 610 at one time and publish the same episode via a second feed 616 at a different time. As will be appreciated by those skilled in the art, a feed may be accessed over a period of time. In one embodiment, a user may decide between accessing files via the first feed or via the second feed before accessing files via either the first feed or the second feed. In another embodiment, the process 600 may receive a user's payment 622 for access to the second feed after the user has already accessed the first feed (and files thereby) for a period of time.

In one embodiment (not shown), the process 600 performs the publishing an episode via a second feed operation 616 after the receiving user's payment of a fee operation 622. For example, there may be some forms of publishing an episode via a second feed 616 that inherently or simultaneously also provide access to the second feed 624 (e.g., there is no substantial access control for the second feed). As another example, the publishing an episode via a second feed operation 616 may be performed by making accessible the second feed at a location (e.g., a custom URI) only accessible by a particular user.

In one embodiment, the first feed may offer a sequence of episodes on a first schedule, and the second feed may offer the same sequence of episodes on a second schedule. The second schedule may be preferred by a user because, for example, the second schedule may provide episodes on an earlier schedule than the first schedule.

In one embodiment, the first feed may include links to advertisements for the second feed. In another embodiment, the first feed may include links to episodes that are different episodes than the episodes to which the second feed provides links. For example, the first feed may include links to episodes that contain advertisements, inducements, or embedded active code (e.g., scripts, executables) that induce a user access the second feed or aid a user in accessing the second feed.

In another embodiment, the second feed provides access to certain files, and the first feed does not provide access to these certain files. For example, a first feed may provide access to a standard group of episodes, and the second feed may provide access to outtakes, extra scenes or extra episodes. In yet another embodiment, the second feed provides access to files that are archived, in a “back catalog” or otherwise more difficult to access through other methods.

In yet another embodiment, the second feed provides access to groups of files that do not contain advertisements. For example, a first feed may be accessed (and files accessed thereby) without a monetary fee, because of advertisements contained in the files or proceeding the files. A second feed may allow a user to pay a monetary fee for access instead of having advertisements included in files or interspersed between files that the user accesses. As noted above, this is a substitution of one fee for another; the substitution of a monetary fee for a non-monetary fee of having advertisements included or interspersed in files.

The process 600 illustrates one embodiment of an order in which the process may be performed. In another embodiment, generating a second feed 614 and publishing an episode via the second feed 616 may both be performed after waiting 620 for a user's payment of a fee for access to the second feed 622. In another embodiment, generating a second feed 614, publishing an episode via the second feed 616, and providing the user access to the second feed 624 may be performed in response to a user viewing an advertisement.

FIG. 2 is an illustration of an embodiment of a publishing entity 200. The publishing entity 200 includes a directive information transceiver 202, a feed transceiver 204, a publishing criteria database 206, a feed database 212, and a feed generator 208. The publishing entity 200 may be located in a single computing machine (e.g., computer, server, hand-held device) or distributed over a number of machines. In one embodiment, the directive information transceiver 202 and feed transceiver 204 interface with publishers and/or servers over the Internet, receiving directive information and feeds from the publishers and/or servers.

The directive information transceiver 202 may transmit the directive information and feeds to appropriate locations, such as a publishing criteria database 206 and a feed database 212, each of which may be located remotely, such as on separate computers or servers. In one embodiment, the publishing criteria database 206 the directive information received to create a publishing criterion for use in relation to publishing media files stored in the media file database 210.

In one embodiment, the directive information transceiver 202 receives directive information comprising publishing criteria, files, and feeds, and then the directive information transfers these components to the publishing criteria database 206, the media file database 210, and the feed database 212, respectively. In another embodiment, the feed transceiver 204 receives a feed referencing a media file; the directive information transceiver 202 receives directive information including a publishing criterion relating to the media file, subsequently storing the publishing criterion in the publishing criteria database 206; and then, at a later time, the directive information transceiver receives directive information including the media file, subsequently storing the media file in the media file database 210.

The feed generator 208 produces and/or modifies feeds including links to media files. In one embodiment, the feed generator 208 may produce a feed by modifying another feed. The modifying may be performed on links within the (e.g., by adding and/or deleting links within the feed). The feed generator 208 may save the updated feed in the same location as the feed on which the modifying was performed, or may save the updated feed in a different location. In one embodiment, the feed generator 208 uses a publishing criterion stored in the publishing criteria database 206 to create and manage feeds.

After creating a feed, the feed generator 208 may send the feed to the feed database 212 for storage. In one embodiment, the feed generator 208 updates a feed stored in the feed database 212. In another embodiment, the feed generator 208 uses a template feed or master feed stored in the feed database 212 to create and manage other feeds.

The feed generator 208 may use a feed database 212 in many manners. In one embodiment, in response to a particular event occurs that satisfies a publishing criterion, a master feed may be edited to create a feed that is appropriate for the event based on directive information. For example, when a publishing criterion (e.g., stored in the publishing criteria database 206) is satisfied, the feed generator 208 may create a feed that is a variant of the master feed based on the publishing criterion satisfied. In another embodiment, the feed generator 208 creates a feed in advance of a publishing criterion being satisfied, stores the feed in the feed database 212. The publishing entity 200 may then retrieve an appropriate feed from the feed database in response a publishing criterion being satisfied.

The feeds stored in the feed database 212 may be from different sources. In one embodiment, the feed database 212 may store a feed that is generated by the feed generator 208. In another embodiment, the feed database 212 may store feeds that has been received by the feed transceiver 204. For example, the community server may receive a feed from a user as part of or in addition to directive information.

The feed transceiver 204 may transmit a feed from the publishing entity 200. In one embodiment, a feed may be transmitted by the feed transceiver 204 in order to publish the feed. For example, the feed transceiver 204 may transmit a feed to the community server for placement of the feed in an accessible location. In another embodiment, a feed may be transmitted in order for a user to review or revise the feed.

The publishing entity 200 may publish feeds or make feeds accessible as described in detail elsewhere herein. In another embodiment, a link (and/or a feed containing the link) may have been accessible (i.e. referencing a pre-determined location on the network), and the publishing entity 200 makes a file accessible by moving the file to the location named by the feed.

In one embodiment, the publishing entity 200 may be located at least partially on a user's computer. For example, a user wishing to publish files over time may download (to the user's computer) an application for formatting directive information. In another embodiment, a publishing entity 200 may be provided on the user's computer to create feeds and supply the feeds to a community server.

The publishing entity 200 may include a media file database 210. In one embodiment, the publishing entity 200 may use the media file database 210 in much the same way as the community server 118 uses media file database 120. In another embodiment, the publishing entity may use the media file database 210 to publish files via moving the files into accessible locations.

FIG. 3 is an illustration of an embodiment of directive information database 300. The directive information database 300 includes information used by a publishing entity (e.g., 184, 200) to publish media files. The directive information database 300 includes a media file database 302, media file identifiers 304, locations 306 corresponding to media files, and publishing criteria 308.

The directive information database 300 may also include a directive information transceiver 310, which may function similarly to the directive information transceiver 202 described with respect to FIG. 2. The directive information transceiver 310 may provide communications (e.g., directive information exchange) between the directive information database 300 and other entities.

Media file identifiers 304 identify media files so that the directive information database 300 may distinguish one media file from another media file. However, media file identifiers 304 do not need to be unique as long as the media file identifier can be used to identify the appropriate media file.

The directive information database 300 may distinguish a media file from other media files in many manners. For example, the location 306 of a media file may distinguish a media file from other media files. In one embodiment, a media file identifier 304 is the name of a media file. For example, a media file may be named “episode_one.mpg” and may be located at ftp://123.234.198.56/root. In another embodiment, a media file identifier 304 may be a number or file, such as a file generated from the contents of a media file. For example, the file generated may be a check sum or a histogram of the contents of the media file.

In one embodiment, the media file identifier 304 is generated by the community server, a publishing entity, or the directive information database 300 itself. In another embodiment, the media file identifier 304 is generated by the publisher or the publisher's computer.

In one embodiment, the media file identifier 304 may be created upon submission and/or cataloging of the media file. For example, the media file identifier 304 may be a name given to a media file during the process of a publisher requesting that the media file be automatically published. The name given may include information identifying the process, including, for example, the publisher's internet protocol address, the publisher's account ID, the date and time the process took place, and the date and time the file is to be published. Therefore, the media file identifier 304 may include directive information.

A location 306 may include a predetermined address on a network. In one embodiment, a location 306 may reference a universal location 306 such as a Uniform Resource Identifier (URI). A universal location 306 may be, e.g., http://patentlaw.typepad.com/patent/. Another example of a universal location 306 is http://www.npr.org. In another embodiment, a location 306 may be a relative location 306 such as a folder name. A relative location 306 may be, for example, c:/media_files/files_to_publish (referring to a location 306 on a publisher's computer). In another embodiment, a relative location 306 may be a position in a list of media files. For example, a relative location 306 may be designated “file 27”.

Publishing criteria 308 may include the occurrence of events, times or any perceptible or discernable phenomenon. In one embodiment, publishing criteria may include the detection of a phone call, the occurrence of a keyword in a newspaper headline, the occurrence of a keyword in an RSS feed, the detection of an electronic message, a pseudo-random occurrence, and a counter reaching a certain number. For example, publishing criteria 308 may include any perceptible occurrence that may trigger an action to occur, such as the publishing of a file by a publishing entity.

Publishing criteria 308 may also be used in many manners. In one embodiment, the publishing criterion 308 may be utilized as an input to a look-up table (LUT), the LUT containing media file identifiers 304 and locations 306. In another embodiment, a software call may be made to a program when a publishing criterion 308 is met, and the program may return media file identifiers 304 and locations 306. In another embodiment, the publishing criteria 308 are stored with the media file identifiers 304 and are used to generate links to locations 306.

In one embodiment, a publishing entity may generate an event that satisfies a publishing criterion 308. For example, a publishing entity may keep a clock running in order to check the clock against a publishing criterion 308 that contains a time. In one embodiment, a publishing entity may generate other events through, for example, performing web searches, monitoring traffic loads on parts of the Internet 104, and monitoring/performing a sequence of events. In another embodiment, a publishing entity may participate in events to some extent (through generating or collecting data), and may receive input about events to some extent. For example, a publishing entity may operate a clock and check it against information received about events on the Internet 104 in order to determine whether a publishing criterion 308 has been satisfied, such as “publish at the earliest of (1) 04:00 Eastern Standard Time or (2) the modifying of the feed on http://imware.clickability.com.”

In one embodiment, there is at least one media file identifier 304, at least one location 306, and at least one publishing criterion 308 associated with each media file referenced in the media file database 302. For example, two publishing criteria 308 may be associated with a single media file. One publishing criterion 308 may have a date, a time and a fee associated with the access to the file, while another publishing criterion 308 may have a later publishing date and/or time and no fee associated with the access to the file. In another embodiment, for each media file referenced in the media file database 302, there is only one corresponding media file identifier 304, location 306, and publishing criterion 308. In one embodiment, publishing criteria 308 are associated with different locations 306, but are associated with the same media file.

In one embodiment, there are multiple locations 306 and/or media files associated with a publishing criterion 308. In another embodiment, there are one-to-one relationships between each publishing criterion 308, each location 306 and each media file identifier 304. In another embodiment, a publishing criterion 308 may correspond to a single media file, but may reference several locations 306 as alternate locations where the media file may be located. In an embodiment, there is a one-to-one relationship between a media file identifier 304 and a media file. In another embodiment, there is a plurality of media files associated with a single media file identifier 304. Therefore, a media file identifier 304 may reference a plurality of media files, such that by using the media file identifier, the directive information database 300 may include the plurality of media files in the feed that is created in response to a publishing criterion 308.

Directive information may be stored in many manners. For example, the media files, the media file identifiers 304, the locations 306, and the publishing criteria 308, may each be stored separately. In one embodiment, the media file identifiers 304, the locations 306, and the publishing criteria 308 may be stored as a database through which the publishing criteria are checked. In another embodiment, if a publishing criterion 308 is met, a media file identifier 304 and a location 306 corresponding to the publishing criterion is matched to the publishing criterion.

Directive information may be used in many manners. In one embodiment, a publishing entity may use the directive information stored in the directive information database 300 to create feeds based on a publishing criterion 308. In another embodiment, a publishing entity may use the directive information database 300 to create a template feed or master feed from which other feeds may be created based on a publishing criterion 308.

FIG. 7 illustrates an embodiment of a graphical user interface (GUI) 700 for presenting a publishing scheduler. The GUI 700 comprises a plurality of interface elements, though, in some embodiments, the GUI may include only one interface element. An interface element may be any definable element of a GUI able to provide or receive information from a user. Exemplary interface elements include pictures with embedded scripts allowing the pictures to be clicked (e.g., “clickable pictures”) or scrolled, text input boxes, buttons, interactive calendars, sliders, and pop-up windows. Other interface elements include radio buttons, text input fields, jog wheels, pull-down lists, sound inputs/outputs (e.g., for creating voice introductions/announcements for each episode), visual inputs/outputs (e.g., for recording a greeting, viewing/uploading pictures), download buttons, and media player windows. Those skilled in the art will recognize that there are other inputs/interfaces that may be utilized as well by the GUI 700. The interface elements described and illustrated herein with respect to GUI 700 are examples and are not meant to limit a GUI to the described embodiment, which is provided for illustration of some of the properties that a GUI may possess.

The GUI 700 includes several input fields where a user (e.g., a publisher) may input information, including directive information, relating to a series of episodes. The GUI 700 includes a series identification field 702 and episode identification fields 716. The GUI 700 also includes a publishing day field 704, a publishing month field 705, a publishing year field 706, and a publishing time field 707 corresponding to each series and/or episode. The GUI 700 includes a regular interval selection field 714, an additional episode selection field 720, and an additional series selection field 722. The additional episode selection field 720 and the additional series selection field 722 may allow a user to add episodes/series to be published by the publishing scheduler (e.g., through a publishing entity).

The GUI 700 includes a series identification field 702 and publishing fields 704-707 associated with the series name field. In one embodiment, a user may choose to publish a series on a different date and/or at a different time than any of the episodes in the series. Therefore, as discussed above, a series may be published and treated in many similar ways as an episode or file. In another embodiment, a user may choose to publish a series on a first date, along with a few episodes. The user may also wish to publish each additional episode weekly thereafter.

The episode identification fields 716 may be used to identify files to be used as episodes. For example, a browse control (not shown) may be provided to allow the user to select an episode from its local computer that, upon completion of the data input, are then automatically uploaded to the publishing server. Alternatively, the episodes may be previously provided and identified by name only, or may be located on the network already in which case the network location is provided in the episode identification fields 716.

The GUI 700 also includes a regular interval selection field 714. In one embodiment, the regular interval selection field 714 may interface with the date/time selected for publishing the series. For example, a user may set a series to be published on May 1, 2006, and may select a weekly publishing of the episodes thereafter. In another embodiment, a user may select a group of episodes (e.g., an initial group of episodes that will be available in the series, the first episode in the series) to be published simultaneously with the series, with each following episode to be published at a regular interval thereafter (e.g., monthly). In yet another embodiment, a user may select instantaneous publishing for some files, regular intervals for publishing some files, and specific dates/times for publishing some files.

The GUI 700 may also include an interface to include events other than the occurrence of a date and time. For example, the GUI 700 may include a pull down list of event types such as the events described herein. This pull down list may be associated with an input field where a user may specify, for example, a web site which should be checked for updates, a keyword which should be checked for its appearance, a type of keyword searches on the network that should be monitored, or a type of network traffic that should be monitored. In another embodiment, the input field may also accept from a user a location of a feed, the modifying of which will constitute an event.

The GUI 700 may also include dates for removing, restricting, or eliminating access to a file. In one embodiment, the GUI 700 may include a radio button (not shown) that changes the interpretation of publishing fields (e.g., 704-707) between referring to a date and time to make accessible, and a data and time to make inaccessible. In another embodiment, the GUI 700 may interpret the publishing fields 704-707 associated with a first instance of an episode in an episode name field as meaning “make accessible at this date and time.” The GUI 700 may interpret the publishing fields 704-707 associated with a second instance of an episode in an episode name field as meaning “make inaccessible at this date and time.”

Those skilled in the art will recognize that the methods and systems of the present invention within this specification may be implemented in many manners and as such is not to be limited by the foregoing exemplary embodiments and examples. In addition, functional elements being performed by a single or multiple components, in various combinations of hardware and software, and individual functions may be distributed among software applications at either the client or server level. In this regard, any number of the features of the different embodiments described herein may be combined into one single embodiment and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known and features of those variations and modifications through the system component described herein as would be understood by those skilled in the art.

What is claimed is:

1. A computer-implemented method of providing access over time to a plurality of episodes via a feed comprising:
receiving a master feed identifying a plurality of future times associated with at least one of a plurality of media files;
detecting the occurrence of a first time corresponding to one of the plurality of future times;
automatically generating a first feed in response to the detecting the occurrence of the first time, the generating the first feed comprising modifying a first copy of the master feed, the first feed comprising a first link to at least one of the plurality of media files;
automatically making the first feed accessible in response to the detecting the occurrence of the first time;
detecting the occurrence of a second time corresponding to one of the plurality of future times, the second time different from the first time;
automatically generating a second feed in response to the detecting the occurrence of the second time, the generating the second feed comprising modifying a second copy of the master feed, the second feed comprising a second link to at least one of the plurality of media files;
automatically making the second feed accessible in response to the detecting the occurrence of the second time.

2. The method of claim 1, further comprising:
receiving at least one of the plurality of media files before the occurrence of the first time and before the occurrence of the second time.

3. The method of claim 1, further comprising:
moving at least one of the plurality of media files in response to the detecting of the occurrence of the first time.

4. The method of claim 1, wherein the master feed comprises a plurality of network access locations corresponding to the plurality of media files.

5. A computer-implemented method of providing access over time to a plurality of episodes via a feed comprising:
receiving directive information, the directive information identifying a first episode as being at a first network access location and as being associated with a first event; the directive information further identifying a second episode as being at a second network access location and as being associated with a second event different from the first event;
detecting the first event; and
making accessible a first feed in response to detecting the first event, the first feed comprising a first link to the first episode at the first network access location.

6. The method of claim 5, further comprising:
detecting the second event;
making accessible a second feed in response to detecting the second event, the second feed comprising a second link to the second episode at the second network access location.

7. The method of claim 6, wherein making accessible the second feed further comprises:
creating the second feed by modifying the first feed to include the second link to the second episode at the second network access location.

8. The method of claim 7, wherein modifying the first feed further comprises:
overwriting the first feed with the second feed.

9. The method of claim 5, further comprising:
storing a template including the directive information;
creating the first feed and the second feed from the template.

10. The method of claim 9, wherein receiving further comprises:
receiving the template, the template containing the directive information.

11. The method of claim 10, wherein the template is a feed referencing each of the series of episodes.

12. The method of claim 5, wherein each episode is a media file.

13. The method of claim 5, wherein the receiving directive information is performed at a first time, wherein the first event is an occurrence of a second time after the first time.

14. The method of claim 5, wherein the first event is selected from: a detection of a phone call, an occurrence of a keyword in a newspaper headline, a detection of an electronic message, a pseudo-random occurrence, and a counter reaching a certain number.

15. The method of claim 5, further comprising:
moving the first episode to the first network access location.

16. The method of claim 15, wherein the first episode is not accessible at the first network access location when the directive information is received; and
the moving the first feed operation is performed in response to detecting the first event.

17. The method of claim 1, further comprising:
receiving the first episode and the second episode with the directive information.

18. The method of claim 5, wherein making accessible the first feed comprises:
moving the first feed to an accessible location.

19. The method of claim 5, wherein the first feed lacks a link to the second episode at the second network access location.

20. The method of claim 5, further comprising:
transmitting a notification that the first event has been detected.

21. The method of claim 5, wherein the first network access location is represented by a first uniform resource identifier (URI) and the second network access location is represented by a second URI.

22. A system for automatically modifying a feed over time comprising:
directive information including a first location relating to a first media file and a first publishing criterion relating to the first media file, wherein the first publishing criterion is independent from the creation, reception and/or transmission of the directive information;
wherein the directive information includes a second location relating to a second media file and a second publishing criterion relating to the second media file, the second publishing criterion different from the first publishing criterion; and
a publishing entity adapted to make the first media file accessible based on the directive information;
wherein the publishing entity is adapted to make the first media file accessible by modifying a first feed in response to a detection of the first publishing criterion being satisfied, the modifying of the first feed comprising modifying the first feed to include a first link to the first media file;
wherein the publishing entity is adapted to receive directive information from a user before the first publishing criterion is satisfied.

23. The system of claim 22, wherein the publishing entity is adapted to move the first media file to the first location in response to detection of the first publishing criterion being satisfied.

24. The system of claim 22, wherein the publishing entity is adapted to make the first media file accessible via moving the first feed to an accessible location.

25. The system of claim 22, wherein the publishing entity is adapted to make the second media file accessible, based on the directive information.

26. The system of claim 25, wherein the publishing entity is adapted to make the second media file accessible by modifying a second feed in response to detection of the second publishing criterion being satisfied, the modifying of the second feed comprising modifying the second feed to include a second link to the second media file.

27. The system of claim 22, wherein the publishing entity is adapted to receive directive information and an episode.

28. The system of claim 27, wherein the publishing entity is further adapted to receive a template containing directive information and is adapted to modify the first feed based on the template.

29. A method comprising:
publishing via a first feed a series of episodes according to a first schedule;
publishing via a second feed the series of episodes according to a second schedule; and
providing access to the second feed for a fee.

30. The method of claim 29, wherein the fee is paid in exchange for a user accessing advertisements associated with an episode.

31. The method of claim 29, further comprising:
receiving directive information pertaining to providing access to the series of episodes according to the first schedule and providing access to the series of episodes according to the second schedule.

32. The method of claim 31, wherein the directive information comprises information selected from: location information for the series of episodes, scheduling information relating to the first schedule and the second schedule, and fee information relating to the second schedule.

33. The method of claim 31, further comprising:
generating the first feed from the directive information; and
generating the second feed from the directive information.

34. The method of claim 29, further comprising:
receiving a request for the second feed from a user;
billing the user for the fee.

35. The method of claim 34, wherein billing the user further includes:
receiving account information of the user, selected from: credit card information, an online debit account information, and bank account information.

36. The method of claim 29, wherein the publishing via the first feed further includes:
moving the series of episodes to an accessible location according to the first schedule.

37. The method of claim 29, wherein the publishing via the second feed further includes:
moving the series of episodes to an accessible location according to the second schedule.

38. The method of claim 29, wherein publishing via the first feed further comprises:
modifying the first feed according to the first schedule.

39. The method of claim 38, wherein modifying the first feed further comprises:
moving the first feed.

40. The method of claim 29, wherein publishing via the second feed further comprises:
modifying the second feed according to the second schedule.

41. The method of claim 40, wherein modifying the second feed further comprises:
moving the second feed.
